(19) United States
(12) Patent Application Publication
(10) Pub. No.: US 2004/0258956 A1
(43) Pub. Date: Dec. 23, 2004

(54) Organic electroluminescent device

(76) Inventor: Noriyuki Matsusue, Osaka (JP)

Correspondence Address: MCDERMOTT, WILL & EMERY, 600 13th Street, N.W., Washington, DC, 20005-3096, US

(21) Appl. No.: 10/813,632

(22) Filed: Mar. 31, 2004

(30) Foreign Application Priority Data
Mar. 31, 2003 (JP) 2003-097304
Mar. 25, 2004 (JP) 2004-090610

(51) Int. Cl. H05B 33/14

(52) U.S. Cl. 428/690; 428/917; 313/504

(57) ABSTRACT

An organic EL device has a stacked structure including a hole injection electrode (an anode), an organic compound layer, and an electron injection electrode (a cathode) in this order on a substrate. The organic compound layer comprises a hole injection layer, a hole transport layer, a light emitting layer, a hole blocking layer, and an electron injection layer. The light emitting layer contains a host material composed of an organic material, a luminescent dopant, and an assisting dopant. Each of the luminescent dopant and the assisting dopant is composed of an organic material for converting triplet excitation energy into luminescence. The assisting dopant assists in movement of the excitation energy, and assists in transportation of carriers.

### BACKGROUND OF THE INVENTION

1. Field of the Invention

The present invention relates to an organic electroluminescent device.

2. Description of the Background Art

In recent years, the needs for flat panel display elements whose power consumption is lower than that of CRTs (Cathode-Ray Tubes) which have been generally employed have increased as information equipment is diversified. As one type of the flat panel display elements, organic electroluminescent (hereinafter abbreviated as organic EL) devices having the properties of having a high efficiency, being thin and lightweight, and having low viewing angle dependency have been paid attention to.

Each organic EL device is a self-luminescent type element that injects electrons and holes into a light emitting layer composed of an organic material, respectively, from an electron injection electrode and a hole injection electrode, recombines the injected electrons and holes at a luminescent center to bring an organic molecule into an excited state, and emits light when the organic molecule is returned from the excited state to a ground state.

Examples of an excited state produced by recombination of carriers include a singlet excited state and a triplet excited state. Many of the organic EL devices conventionally developed emit light (fluorescence) due to an energy difference in a case where they are returned from the singlet excited state to a ground state (singlet excitation energy). Such conventional organic EL devices provide only fluorescence, while not providing luminescence (phosphorescence) due to an energy difference in a case where they are returned to the ground state through the triplet excited state (triplet excitation energy).

Quantum mechanical consideration has found that the ratio of the formation probability of a singlet exciton in a singlet excited state to the formation probability of a triplet exciton in a triplet excited state is statistically 1:3. In the conventional organic EL devices using only singlet excitation energy, therefore, the luminous efficiency (internal quantum efficiency) thereof is 25% of total excitation energy (the sum of singlet excitation energy and triplet excitation energy).

In order to improve the luminous efficiencies of the organic EL devices, therefore, various methods for contributing triplet excitation energy to luminescence have been contrived.

M. A. Baldo et al. disclose, as the organic EL device that contributes triplet excitation energy to luminescence, an organic EL device using for a light emitting layer Tris(2-phenylpyridine)iridium) (hereinafter abbreviated as Ir(ppy)3) which is an ortho metalated complex (see M. A. Baldo et al., Applied Physics Letters, Vol. 75, No. 1, p4, (1999)). Ir(ppy)3 is expressed by the following chemical formula (5):

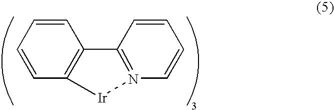

The organic EL device provides green luminescence at a significantly high efficiency and therefore, can have a luminous efficiency which is approximately two to three times that of a conventionally general organic EL device emitting green light.

Furthermore, S. Lamansky et al. disclose, as the organic EL device that contributes triplet excitation energy to luminescence, an organic EL device using for a light emitting layer Bis(2-2′-benzothienyl)-phyridinato-N,C3)Iridium(acetylacetonate)) (hereinafter abbreviated as btp2Ir(acac)) which is an ortho metalated complex (see S. Lamansky et al., J. Am. Chem. Soc., 123, 4304-4312 (2001)). btp2Ir(acac) is expressed by the following chemical formula (6):

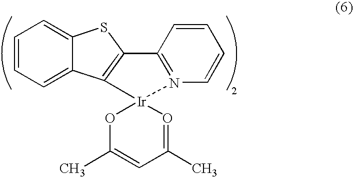

The organic EL device can provide red luminescent.

However, the organic EL device using btp2Ir(acac) can have only a luminous efficiency which is approximately one to 1.5 times that of the conventionally general organic EL device.

Although the luminous efficiency of the organic EL device is thus improved by using an organic material for contributing triplet excitation energy to luminescence (for converting triplet excitation energy into luminescence) (hereinafter referred to as a triplet organic material), the luminous efficiency varies depending on an organic material to be used.

When full-color display is realized, organic EL devices respectively emitting red light, blue light, and green light are required. As described above, the organic EL device emitting green light can have a high luminous efficiency by using the triplet organic material. On the other hand, it is difficult for the organic EL devices respectively emitting red light and blue light to have high luminous efficiencies even when they use the triplet organic material.

### SUMMARY OF THE INVENTION

An object of the present invention is to provide an organic electroluminescent device that can have a sufficient luminous efficiency irrespective of its luminescent color.

An organic electroluminescent device according to a first aspect of the present invention comprises a hole injection electrode, a light emitting layer, and an electron injection electrode in this order, the light emitting layer containing a luminescent dopant capable of converting triplet excitation energy into luminescence, and an assisting dopant composed of a material capable of converting triplet excitation energy into luminescence and assisting in movement of the excitation energy to the luminescent dopant.

In the organic electroluminescent device, the triplet excitation energy is converted into the luminescence by the luminescent dopant, thereby making it possible for the organic electroluminescent device to have a high luminous efficiency. Further, the triplet excitation energy is moved to the luminescent dopant by the assisting dopant, thereby making it possible for the organic electroluminescent device to have a much higher luminous efficiency irrespective of its luminescent color by the luminescent dopant.

An organic electroluminescent device according to another aspect of the present invention comprises a hole injection electrode, a light emitting layer, and an electron injection electrode in this order, the light emitting layer containing a luminescent dopant capable of converting triplet excitation energy into luminescence, and an assisting dopant composed of a material capable of converting triplet excitation energy into luminescence and assisting in transportation of carriers to the luminescent dopant.

In the organic electroluminescent device, the triplet excitation energy is converted into the luminescence by the luminescent dopant, thereby making it possible for the organic electroluminescent device to have a high luminous efficiency. Further, the triplet excitation energy is converted into the luminescence by the assisting dopant, and the assisting dopant assists in the transportation of the carriers to the luminescent dopant, thereby making it possible for the organic electroluminescent device to have a much higher luminous efficiency irrespective of its luminescent color by the luminescent dopant.

The assisting dopant may include an ortho metalated complex. By using the assisting dopant, the triplet excitation energy is converted into the luminescence, thereby making it possible to obtain a high luminous efficiency.

The ortho metalated complex may include a platinum group element. Consequently, it is possible to obtain a high luminous efficiency.

The assisting dopant includes an organic compound having a molecular structure expressed by any one of the following formulas (1) to (4), M in the formulas (1) to (4) may be a platinum group element, R1 to R4 may be a hydrogen atom, a halogen atom, or a substituent, and n1 to n4 may be integers from 1 through 3.

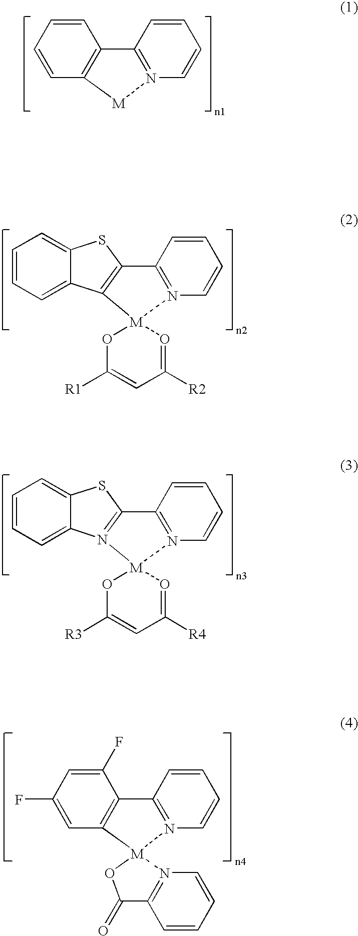

By using the assisting dopant, it is possible to obtain a high luminous efficiency.

The platinum group element may be a metal selected from a group consisting of iridium, platinum, osmium, ruthenium, rhodium, and palladium. Consequently, it is possible to obtain a high luminous efficiency.

The content of the luminescent dopant in the light emitting layer may be not less than 1% by weight nor more than 20% by weight. In this case, good luminescence by the luminescent dopant is obtained.

The content of the assisting dopant in the light emitting layer may be not less than 1% by weight nor more than 20% by weight. In this case, good luminescence by the luminescent dopant is obtained, and a high luminous efficiency can be obtained.

The energy gap of the assisting dopant may be greater than the energy gap of the luminescent dopant. In this case, the assisting dopant assists in the movement of the excitation energy, so that the excitation energy in the light emitting layer moves smoothly, thereby improving the luminous efficiency of the organic electroluminescent device.

The light emitting layer may further contain a host material, the energy level H0 of the highest occupied molecular orbit of the host material, the energy level H1 of the highest occupied molecular orbit of the luminescent dopant, and the energy level H2 of the highest occupied molecular orbit of the assisting dopant may satisfy a relationship of H0>H2>H1, and the energy level L0 of the lowest unoccupied molecular orbit of the host material, the energy level L1 of the lowest unoccupied molecular orbit of the luminescent dopant, and the energy level L2 of the lowest unoccupied molecular orbit of the assisting dopant may satisfy a relationship of L0>L2>L1. In this case, the assisting dopant assists in the movement of the excitation energy, so that the excitation energy in the light emitting layer moves smoothly, thereby improving the luminous efficiency of the organic electroluminescent device.

The assisting dopant may emit light. In this case, the assisting dopant emits light, thereby improving the luminous efficiency of the organic electroluminescent device.

The luminous intensity of the assisting dopant may be not more than 30% of the luminous intensity of the luminescent dopant. In this case, the luminous efficiency of the organic electroluminescent device is improved, and the luminescent color thereof by the luminescent dopant can be reliably obtained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic sectional view showing an example of an organic EL device according to a first embodiment;

FIG. 2 is a schematic view showing an example of the energy levels of the lowest unoccupied molecular orbit (LUMO) and the highest occupied molecular orbit (HOMO) of each of a hole transport layer, a light emitting layer, and a hole blocking layer in the organic EL device according to the first embodiment and the movement courses of electrons and holes;

FIG. 3 is a schematic sectional view showing an example of an organic EL device according to a second embodiment;

FIG. 4 is a schematic plan view showing an example of an organic EL display device using the organic EL device according to the first embodiment;

FIG. 5 is a cross-sectional view taken along a line A-A of the organic EL display device shown in FIG. 4;

FIG. 6 is a graph showing luminescent properties in examples 1 to 3 and an comparative example 1; and

FIG. 7 is a graph showing luminescent properties in an example 4 and a comparative example 2.

### DESCRIPTION OF THE PREFERRED EMBODIMENTS

Description is now made of an organic electroluminescent (hereinafter abbreviated as organic EL) device according to an embodiment of the present invention.

(First Embodiment)

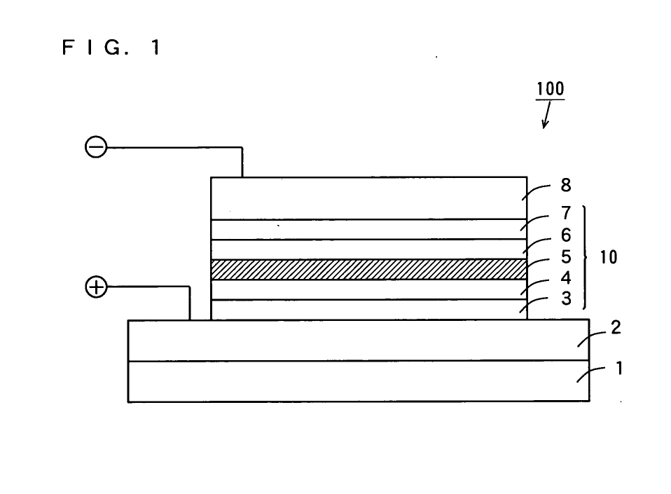

FIG. 1 is a schematic sectional view showing an example of an organic EL device according to a first embodiment. The organic EL device 100 according to the first embodiment has a stacked structure including a hole injection electrode (an anode) 2, an organic compound layer 10, and an electron injection electrode 8 (a cathode) in this order on a substrate 1. The organic compound layer 10 comprises a hole injection layer 3, a hole transport layer 4, alight emitting layer 5, a hole blocking layer 6, and an electron injection layer 7.

The substrate 1 is a transparent substrate composed of glass, plastic, or the like. The hole injection electrode 2 is a transparent electrode or a translucent electrode composed of a metal compound such as an indium-tin oxide (hereinafter abbreviated as ITO), a metal such as silver, or an alloy. The electron injection electrode 8 is a transparent electrode, a translucent electrode, or an opaque electrode composed of a magnesium-indium alloy or a metal compound such as an ITO, a metal, or an alloy.

In the organic compound layer 10, the hole injection layer 3 is composed of an organic material such as Copper phthalocyanine (hereinafter abbreviated as CuPc) expressed by the following formula (7), for example:

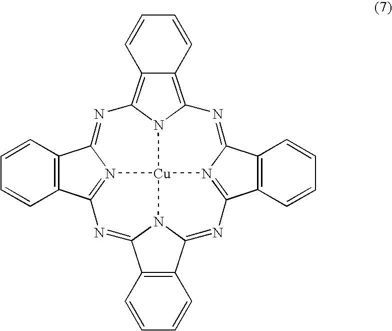

The hole transport layer 4 is composed of an organic material such as N, N′-Di(naphthalene-1-yl)-N,N′-diphenylbenzidine (hereinafter abbreviated as NPB) expressed by the following formula (8), for example:

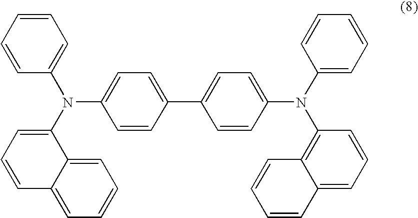

The hole blocking layer 6 is composed of an organic material such as 2,9-Dimethyl-4,7-diphenyl-1,10-phenanthroline (hereinafter abbreviated as BCP) expressed by the following formula (9), for example:

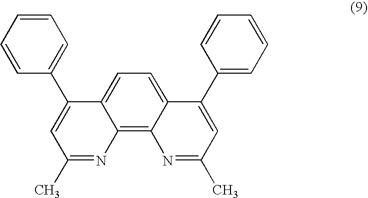

The electron injection layer 7 is composed of an organic material such as Tris(8-hydroxyquinolinato)aluminum (hereinafter abbreviated as Alq) expressed by the following formula (10), for example:

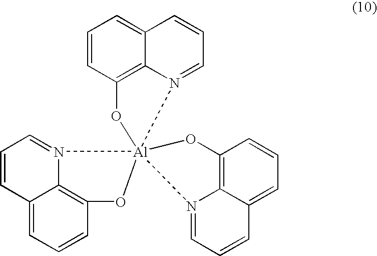

The light emitting layer 5 is composed of a host material, a luminescent dopant, and an assisting dopant, described later. The details of various types of organic materials used for the light emitting layer 5 will be described later.

When a drive voltage is applied between the hole injection electrode 2 and the electron injection electrode 8 in the organic EL device 100, the light emitting layer 5 emits light. The light produced in the light emitting layer 5 is emitted outward through the hole transport layer 4, the hole injection layer 3, the hole injection electrode 2, and the substrate 1. A device structure in which the light thus produced in the light emitting layer 5 is emitted outward through the substrate 1 is referred to as a back emission structure.

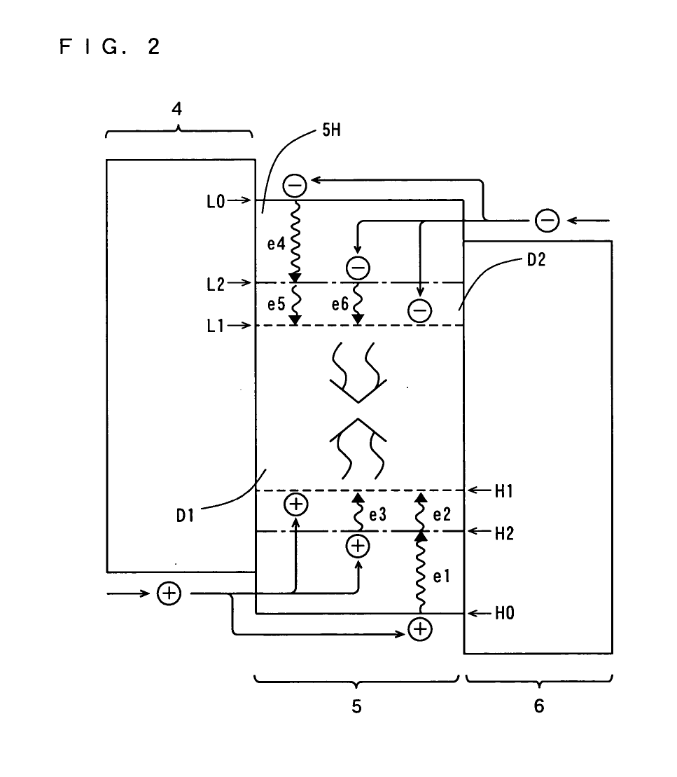

A mechanism for emitting light in the light emitting layer 5 and the organic material used for the host material, the luminescent dopant, and the assisting dopant will be described on the basis of FIG. 2.

FIG. 2 is a schematic view showing an example of the energy levels of the lowest unoccupied molecular orbit (LUMO) and the highest occupied molecular orbit (HOMO) of each of the hole transport layer 4, the light emitting layer 5, and the hole blocking layer 6 in the organic EL device 100 according to the first embodiment and the movement courses of electrons and holes.

In the present embodiment, the respective relationships among the energy levels of the LUMO and the HOMO of a host material 5H, a luminescent dopant D1, and an assisting dopant D2 composing the light emitting layer 5 are as follows.

The HOMO (the energy level H2) of the assisting dopant D2 is higher than the HOMO (the energy level H1) of the luminescent dopant D1, and the HOMO (the energy level H0) of the host material 5H is higher than the HOMO (the energy level H2) of the assisting dopant D2.

The LUMO (the energy level L2) of the assisting dopant D2 is higher than the LUMO (the energy level L1) of the luminescent dopant D1, and the LUMO (the energy level L0) of the host material 5H is higher than the LUMO (the energy level L2) of the assisting dopant D2.

That is, the respective relationships among the energy levels of the LUMO and the HOMO of the host material 5H, the luminescent dopant D1, and the assisting dopant D2 are given by the following expressions (11) and (12):

H0>H2>H1 (11)

L0>L2>L1 (12)

When the energy gaps of the host material 5H, the luminescent dopant D1, and the assisting dopant D2 are respectively taken as “E0”, “E1”, and “E2” in this order, the relationship among the energy gaps is given by the following expression (13):

E0>E2>E3 (13)

When a drive voltage is applied between the hole injection electrode 2 and the electron injection electrode 8 in the organic EL device 100 shown in FIG. 1, holes supplied from the hole injection electrode 2 are injected into the hole injection layer 3, and electrons supplied from the electron injection electrode 8 are injected into the electron injection layer 7.

The holes injected into the hole injection layer 3 are transported to the light emitting layer 5 through the hole transport layer 4, and the electrons injected into the electron injection layer 7 are transported to the light emitting layer 5 through the hole blocking layer 6.

The holes transported from the hole transport layer 4 to the light emitting layer 5 are moved to the LUMO of each of the host material 5H, the luminescent dopant D1, and the assisting dopant D2.

When the carrier transport capability of the assisting dopant D2 is high, carrier transport properties among the hole transport layer 4, the hole blocking layer 6, and the light emitting layer 5 are improved.

In the light emitting layer 5, the holes at the energy level H0 are moved to the energy level H1 or H2, as indicated by arrows e1 and e2. The holes at the energy level H2 are moved to the energy level H1, as indicated by an arrow e3.

The electrons transported from the hole blocking layer 6 to the light emitting layer 5 are moved to the HOMO of each of the host material 5H, the luminescent dopant D1, and the assisting dopant D2.

In the light emitting layer 5, the electrons at the energy level L0 are moved to the energy level L1 or L2, as indicated by arrows e4 and e5. The electrons at the energy level L2 are moved to the energy level L1, as indicated by an arrow e6.

The holes at the energy level H0 and the electrons at the energy level L0 are recombined, and the produced excitation energy is moved to the assisting dopant D2 or the luminescent dopant D1, so that the light emitting layer 5 emits light.

The holes at the energy level H1 and the electrons at the energy level L1 are recombined, and the produced excitation energy is moved to the luminescent dopant D1, so that the light emitting layer 5 emits light.

The holes at the energy level H2 and the electrons at the energy level L2 are recombined, so that the light emitting layer 5 emits light.

When the respective relationships among the energy levels of the LUMO and the HOMO of the host material 5H, the luminescent dopant D1, and the assisting dopant D2 thus satisfy the expressions (11) to (13), the movement of the excitation energy of carries in the light emitting layer 5 is smoothly performed. The reason for this is that the energy levels of the LUMO and the HOMO of the assisting dopant D2 are respectively positioned between the LUMO and the HOMO of the host material 5H and the LUMO and the HOMO of the luminescent dopant D1, thereby assisting in the movement of the excitation energy.

The host material 5H is composed of an organic material such as 4,4′-Bis(carbazol-9-yl)-biphenyl (hereinafter abbreviated as CBP) expressed by the following formula (14), for example:

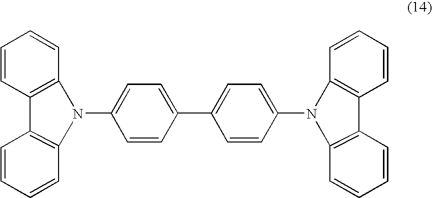

An organic material for contributing triplet excitation energy to luminescence (converting triplet excitation energy into luminescence) (hereinafter referred to as a triplet organic material) is used for the luminescent dopant D1 and the assisting dopant D2.

A triplet organic material containing an ortho metalated complex such as Tris(2-phenylpyridine)iridium (hereinafter abbreviated as Ir(ppy)3), Bis(2-2′-benzothienyl)-pyridinato-N,C3) Iridium(acetylacetonate)) (hereinafter abbreviated as btp2Ir(acac)), Bis(2-phenylbenzothiozolato-N,C2)Iridium(acetylacetonate)) (hereinafter abbreviated as bt2Ir(acac)), or Bis[4,6-difluorophenyl-pyridinato-N,C2]Iridium(picolinato)) (hereinafter abbreviated as FIrpic), for example, is used for the luminescent dopant D1.

Ir(ppy)3 has a molecular structure expressed by the following formula (5):

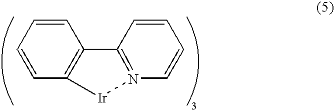

btp2Ir(acac) has a molecular structure expressed by the following formula (6):

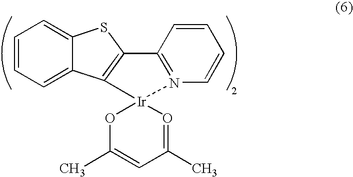

bt2Ir(acac) has a molecular structure expressed by the following formula (15):

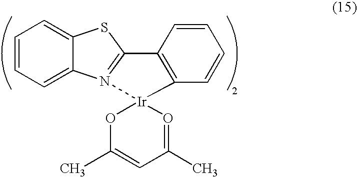

FIrpic has a molecular structure expressed by the following formula (16):

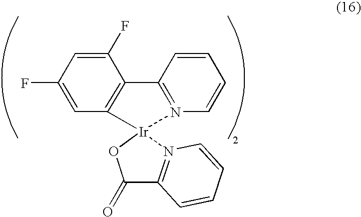

The structural formula of the ortho metalated complex is expressed by the following formulas (1) to (4), for example:

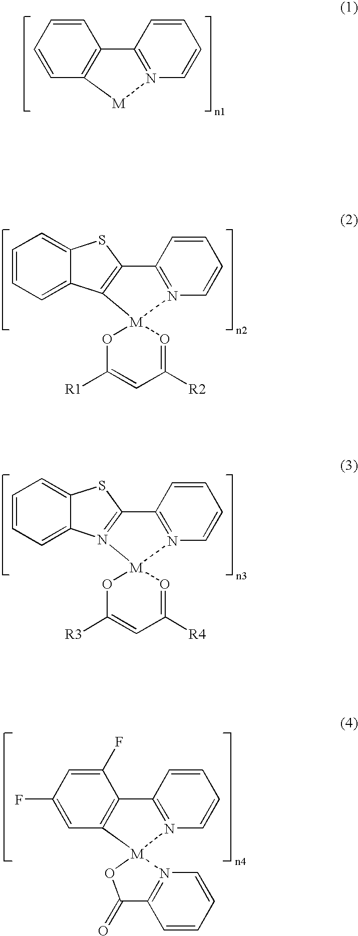

M in the foregoing formulas (1) to (4) is a platinum group element such as iridium (Ir), platinum (Pt), osmium (Os), ruthenium (Ru), rhodium (Rh), or palladium (Pd). Particularly, it is preferable that M is iridium or platinum. Consequently, it is possible to obtain luminescence having a higher luminance at a higher luminous efficiency.

R1 to R4 in the formulas (1) to (4) are a hydrogen atom, a halogen atom, or a substitute. For example, R1 to R4 are —CₙH₂ₙ₊₁ (n=0-10), a phenyl group, a naphthyl group, a thiophene group, —CN, —N(CₙH₂ₙ₊₁)₂ (n=1-10), —COOCₙH₂ₙ₊₁ (n=1-10), —F, —Cl, —Br, —I, —OCH₃, —OC₂H₅, or the like.

The triplet organic material thus composed of the ortho metalated complex containing a platinum group element and a hydrogen atom, a halogen atom or a substitute and having a structure expressed by any one of the formulas (1) to (4) can emit phosphorescence through a triplet excited state.

In this case, selected as the triplet organic material used for the luminescent dopant D1 is one in which the energy levels of the LUMO and the HOMO thereof satisfy the relationships given by the foregoing expressions (11) to (13) with those of the host material 5H and the assisting dopant D2.

The triplet organic material containing the ortho metalated complex such as Ir(ppy)3, btp2Ir(acac), bt2Ir(acac) or FIrpic, for example, is used for the assisting dopant D2, similarly to the luminescent dopant D1.

The molecular structures of Ir(ppy)3, btp2Ir(acac), bt2Ir(acac) and FIrpic are as expressed by the foregoing formulas (5), (6), (15), and (16), respectively.

An example of the structural formula of the ortho metalated complex is as expressed by the foregoing formulas (1) to (4).

In this case, selected as the triplet organic material used for the assisting dopant D2 is one in which the energy levels of the LUMO and the HOMO thereof satisfy the relationships given by the foregoing expressions (11) to (13) with those of the host material 5H and the luminescent dopant D1.

The organic EL device 100 according to the present embodiment thus uses the triplet organic materials, respectively, as the luminescent dopant D1 and the assisting dopant D2. Consequently, the triplet excitation energy of the luminescent dopant D1 and the assisting dopant D2 contribute to luminescence, thereby improving the luminous efficiency of the organic EL device 100.

The energy levels of the LUMO and the HOMO of the host material 5H, the luminescent dopant D1, and the assisting dopant D2 satisfy the relationships given by the foregoing expressions (11) to (13).

That is, the carriers transported from the hole transport layer 4 and the hole blocking layer 6 to the light emitting layer 5 are moved to the energy level of each of the host material 5H, the luminescent dopant D1, and the assisting dopant D2 in the light emitting layer 5. This assists in the transportation of the carriers between the hole transport layer 4 and the light emitting layer 5 and between the hole blocking layer 6 and the light emitting layer 5, thereby improving the luminous efficiency of the organic EL device 100.

The energy levels of the HOMO and the LUMO of the assisting dopant D2 are respectively positioned between the HOMO and the LUMO of the host material 5H and the HOMO and the LUMO of the luminescent dopant D1, thereby assisting in the movement of the excitation energy of the carriers. Consequently, the movement of the excitation energy of the carriers in the light emitting layer 5 is smoothly performed, thereby improving the luminous efficiency of the organic EL device 100.

As described in the foregoing, the organic EL device 100 according to the present embodiment has a sufficient luminous efficiency irrespective of its luminescent color by using the triplet organic material contributing to a high luminous efficiency as well as further using the assisting dopant D2 for realizing a much higher luminous efficiency.

It is desirable that the ratio of the luminescent dopant D1 to be added to the light emitting layer 5 is not less than 1% by weight nor more than 20% by weight. In this case, good luminescence by the luminescent dopant D1 is obtained.

It is desirable that the ratio of the assisting dopant D2 to be added to the light emitting layer 5 is not less than 1% by weight nor more than 20% by weight. In this case, good luminescence by the luminescent dopant D1 is obtained, and a high luminous efficiency is obtained.

The assisting dopant D2 may emit light. In this case, the assisting dopant D2 emits light, thereby improving the luminous efficiency of the organic EL device 100. It is desirable that the luminous intensity of the assisting dopant D2 is not more than 30% of the luminous intensity of the luminescent dopant D1. The reason for this is that when the luminous intensity of the assisting dopant D2 is higher by not less than 30%, the luminescent color of the organic EL device 100 by the luminescent dopant D1 may not, in some cases, be obtained. Consequently, the luminous intensity of the assisting dopant D2 is set to not more than 30% of the luminous intensity of the luminescent dopant D1, thereby improving the luminous efficiency of the organic EL device 100 as well as making it possible to reliably obtain the luminescent color thereof by the luminescent dopant D1.

The organic EL device according to the present embodiment may have a top emission structure in which the light produced emitted in the light emitting layer 5 is emitted outward through the hole blocking layer 6, the electron injection layer 7, and the electron injection electrode 8 by making the electron injection electrode 8 a transparent electrode or a translucent electrode.

In the present embodiment, the structure of the organic compound layer 10 is not limited to the foregoing. Various structures can be used. For example, when an organic material having the properties of the hole injection layer 3 and the hole transport layer 4 is used, the hole injection layer 3 and the hole transport layer 4 may be formed as one layer. When an organic material having the properties of the hole blocking layer 6 and the hole injection layer 7 is used, the hole blocking layer 6 and the electron injection layer 7 may be formed as one layer. Further, an organic material having the properties of the light emitting layer 5 is used together with any one of the hole injection layer 3, the hole transport layer 4, the hole blocking layer 6, and the electron injection layer 7, a plurality of layers may be formed as one layer.

(Second Embodiment)

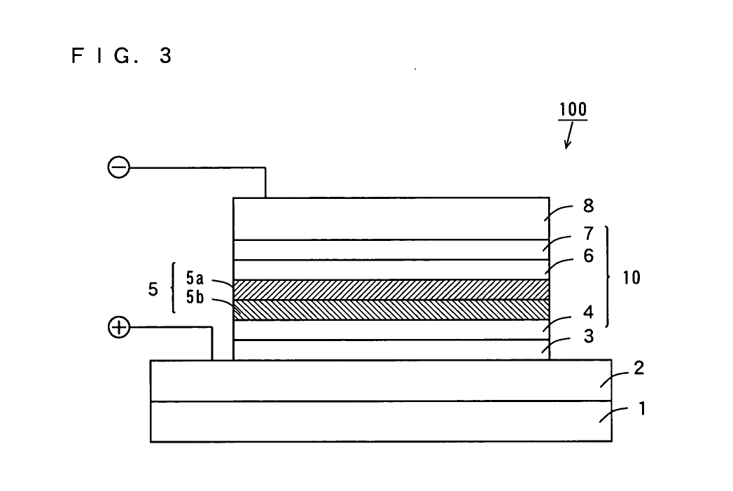

FIG. 3 is a schematic sectional view showing an example of an organic EL device according to a second embodiment. The organic EL device 100 according to the second embodiment has the same structure as that of the organic EL device 100 according to the first embodiment except that a light emitting layer 5 is an orange light emitting layer 5a capable of providing orange luminescence and a blue light emitting layer 5b capable of providing blue luminescence.

In the present embodiment, it is preferable that each of the orange light emitting layer 5a and the blue light emitting layer 5b is formed of a host material, a luminescent dopant D1, and an assisting dopant D2.

It is preferable that the energy levels of the HOMO (H0) and the LUMO (L0) of the host material, the energy levels of the HOMO (H1) and the LUMO (L1) of the luminescent dopant D1, and the energy levels of the HOMO (H2) and the LUMO (L2) of the assisting dopant D2, which are used for the orange light emitting layer 5a and the blue light emitting layer 5b, are set so as to satisfy the relationships given by the expressions (11) to (13) shown in the first embodiment.

For the orange light emitting layer 5a, CBP, btp2Ir(acac), and Ir(ppy)3 may be respectively used as the host material, the luminescent dopant D1, and the assisting dopant D2, for example. For the blue light emitting layer 5b, CBP and FIrpic may be respectively used as the host material and the luminescent dopant D1.

Therefore, the organic EL device 100 according to the present embodiment can have a sufficient luminous efficiency irrespective of its luminescent color by using a triplet organic material for contributing to a high luminous efficiency for at least one light emitting layer as well as further using the assisting dopant D2 for realizing a much higher luminous efficiency.

Furthermore, the orange light emitting layer 5a and the blue light emitting layer 5b emit light, thereby making it possible to obtain white luminescence. In this case, display of the three primary colors of light (RGB display) is made possible by providing the organic EL device capable of providing white luminescence with red, green, and blue filters, thereby realizing full-color display.

(Third Embodiment)

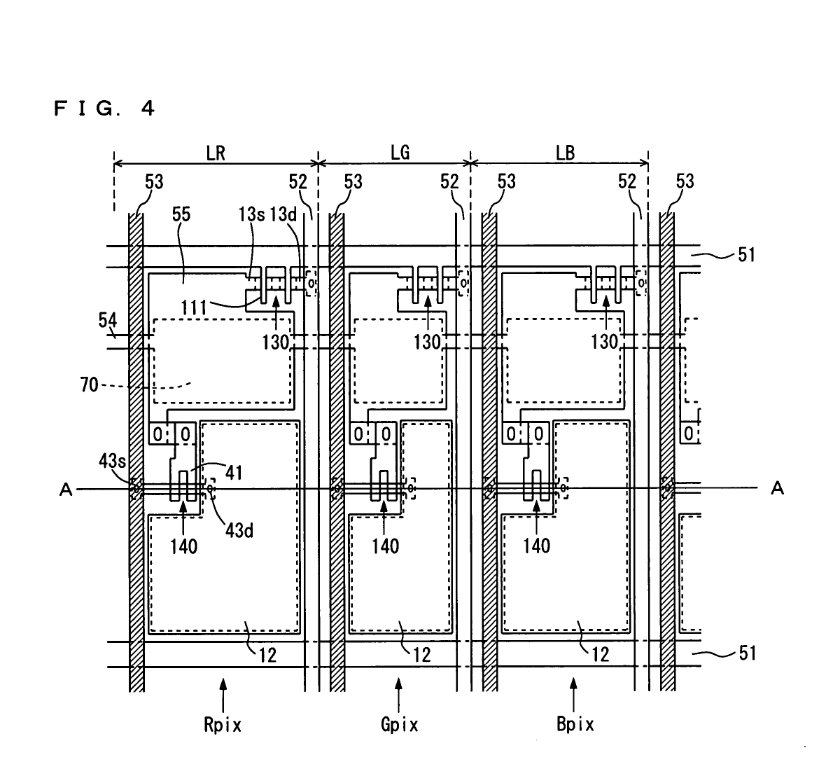

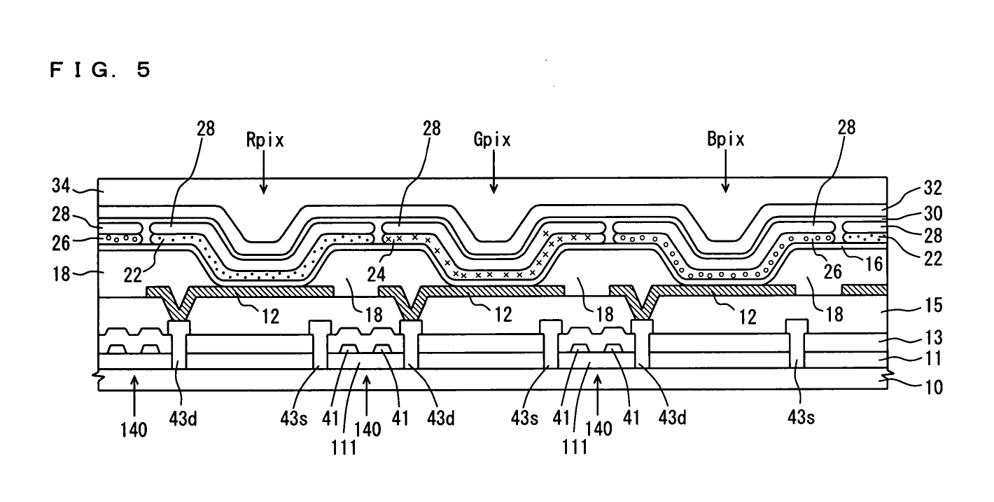

FIG. 4 is a schematic plan view showing an example of an organic EL display device using the organic EL device according to the first embodiment, and FIG. 5 is a cross-sectional view taken along a line A-A in the organic EL display device shown in FIG. 4.

In the organic EL display device shown in FIGS. 4 and 5, a pixel emitting red light (hereinafter referred to an R pixel) Rpix, a pixel emitting green light (hereinafter referred to as a G pixel) Gpix, and a pixel emitting blue light (hereinafter referred to as a B pixel) Bpix are arranged in the form of a matrix. In the following description, each of the R pixel Rpix, the G pixel Gpix, and the B pixel Bpix corresponds to the organic EL device 100 according to the first embodiment.

In the following description, a glass substrate 10, an active layer 11, an interlayer insulating film 13, a first flattening layer 15, a first TFT 130, and a second TFT 140 correspond to the substrate 1 shown in FIG. 1 according to the first embodiment, a hole transport layer 16 corresponds to the hole injection layer 3 and the hole transport layer 4 shown in FIG. 1, a red light emitting layer 22, a green light emitting layer 24, and a blue light emitting layer 26 correspond to the light emitting layer 5 shown in FIG. 1, and an electron transport layer 28 corresponds to the hole blocking layer 6 and the electron injection layer 7 shown in FIG. 1.

In FIG. 4, the R pixel Rpix, the G pixel Gpix, and the B pixel Bpix are provided in this order from the left.

The structures of the pixels are the same in a plan view. One of the pixels is formed in a region enclosed by two gate signal lines 51 extending in a row direction and two drain signal lines (data lines) 52 extending in a column direction. In the region of each of the pixels, an n-channel type first TFT 130 which is a switching element is formed in the vicinity of an intersection of the gate signal line 51 and the drain signal line 52, and a p-channel type second TFT 140 for driving the organic EL device is formed in the vicinity of the center of the region. Further, an auxiliary capacitance 70, and a hole injection electrode 12 composed of ITO are formed in the region of each of the pixels. The organic EL device is formed in an island shape in a region of the hole injection electrode 12.

The first TFT 130 has its drain connected to the drain signal line 52 through a drain electrode 13d, and the first TFT 130 has its source connected to an electrode 55 through a source electrode 13s. A gate electrode 111 in the first TFT 130 extends from a gate signal line 51.

The auxiliary capacitance 70 comprises an SC (Status/Command) line 54 receiving a power supply voltage Vsc and an electrode 55 integrated with the active layer 11 (see FIG. 5).

The second TFT 140 has its drain connected to the hole injection electrode 12 in the organic EL device through a drain electrode 43d, and the second TFT 140 has its source connected to a power supply line 53 extending in a column direction through a source electrode 43s. A gate electrode 41 in the second TFT 140 is connected to the electrode 55.

The width LR of the R pixel Rpix, the width LG of the G pixel Gpix, and the width LB of the B pixel Bpix are respectively set such that the amounts of lights emitted by the R pixel Rpix, the G pixel Gpix, and the B pixel Bpix are equal in consideration of the luminous efficiencies of the organic EL devices. In the present embodiment, the width LR of the R pixel Rpix is 75.5 μm, the width LG of the G pixel Gpix is 56.6 μm, and the width LB of the B pixel Bpix is 66 μm.

As shown in FIG. 5, the active layer 11 composed of polycrystalline silicon or the like is formed on the glass substrate 10, and a part of the active layer 11 is the second TFT 140 for driving the organic EL device. A gate electrode 41 having a double gate structure is formed on the active layer 11 through a gate oxide film (not shown), and the interlayer insulating film 13 and the first flattening layer 15 are formed on the active layer 11 so as to cover the gate electrode 41. Acrylic resin, for example, can be used as a material for the first flattening layer 15. The transparent hole injection electrode 12 is formed for each of the pixels on the first flattening layer 15, and an insulative second flattening layer 18 is formed on the first flattening layer 15 so as to cover the hole injection electrode 12.

The second TFT 140 is formed under the second flattening layer 18. Here, the second flattening layer 18 is formed not on the whole surface of the hole injection electrode 12 but locally so as to cover a region having the second TFT 140 formed therein and so as not to disconnect the hole injection electrode 12 or each of organic material layers, described later, in the shape of the second flattening layer 18.

The hole transport layer 16 is formed on the overall region so as to cover the hole injection electrode 12 and the second flattening layer 18.

The striped red light emitting layer 22, the striped green light emitting layer 24, and the striped blue light emitting layer 26 each extending in a column direction are respectively formed in the areas, on the hole transport layer 16, of the R pixel Rpix, the G pixel Gpix, and the B pixel Bpix.

The boundaries among the striped red light emitting layer 22, green light emitting layer 24, and blue light emitting layer 26 are provided in a region, parallel to the glass substrate 10, on a surface of the second flattening layer 18.

The striped electron transport layers 28 extending in a column direction are respectively formed on the red light emitting layer 22, the green light emitting layer 24, and the blue light emitting layer 26 in the R pixel Rpix, the G pixel Gpix, and the B pixel Bpix.

The light emitting layers 22, 24, and 26 and the electron transport layers 28 in the R pixel Rpix, the G pixel Gpix, and the B pixel Bpix are continuously formed for each color in a multi-chamber type organic EL manufacturing apparatus comprising a plurality of evaporation chambers. That is, the red light emitting layer 22 and the electron transport layer 28 in the R pixel Rpix are continuously formed using a common mask in the first evaporation chamber. The green light emitting layer 24 and the electron transport layer 28 in the G pixel Gpix are continuously formed using a common mask in the second evaporation chamber. Further, the blue light emitting layer 26 and the electron transport layer 28 in the B pixel Bpix are continuously formed using a common mask in the third evaporation chamber. Consequently, the boundaries among the electron transport layers 28 are respectively provided so as to be superimposed on the boundaries among the red light emitting layer 22, the green light emitting layer 24, and the blue light emitting layer 26.

The light emitting layers 22, 24, and 26 and the electron transport layers 28 are respectively formed for the colors in the different evaporation chambers, thereby avoiding cross-contamination of a dopant produced in a case where the light emitting layers 22, 24, and 26 of three types and the electron transport layers 28 are formed in the same evaporation chamber.

Furthermore, a lithium fluoride layer 30 and an electron injection electrode 32 which are common to the electron transport layers 28 are successively formed on each of the electron transport layers 28. A protective film 34 composed of resin or the like is formed on the electron injection electrode 32.

In the above-mentioned organic EL display device, when a selection signal is outputted to the gate signal line 51, the first TFT 130 is turned on, so that the auxiliary capacitance 70 is charged depending on a voltage value (a data signal) fed to the drain signal line 52 at that time. The gate electrode 41 in the second TFT 140 receives a voltage corresponding to a charge given to the auxiliary capacitance 70. Consequently, a current supplied to the organic EL device from the power supply line 53 is controlled, so that the organic EL device emits light at a luminance corresponding to the supplied current.

In the organic EL display device according to the present embodiment, a video can be displayed by thus arranging the organic EL devices 100 according to the first embodiment in the form of a matrix and individually setting their luminescent colors as the R pixel Rpix, the G pixel Gpix, and the B pixel Bpix.

The red light emitting layer 22 may have a structure using CBP as the host material, using btp2Ir(acac) as the luminescent dopant D1, and using Ir(ppy)3 as the assisting dopant D2, for example.

The green light emitting layer 24 may have a structure using CBP as the host material, using Ir(ppy)3 as the luminescent dopant D1, and using FIrpic as the assisting dopant D2, for example.

The blue light emitting layer 26 may have a structure using CBP as the host material and using FIrpic as the luminescent dopant D1, for example. Also in the blue light emitting layer 26, it is desirable that the assisting dopant D2 shown in the first embodiment is used.

As described in the foregoing, in the present embodiment, the luminescent dopant D1 composed of the triplet organic material contributing to a high luminous efficiency is used, and the assisting dopant D2 for realizing a much higher luminous efficiency is used for various types of organic EL devices which respectively provide red luminescence, green luminescence, and blue luminescence, thereby improving their respective luminous efficiencies in the three primary colors (RGB) of light. Consequently, full-color display at a high luminous efficiency is obtained.

### EXAMPLES

Organic EL devices in inventive examples 1 to 4 were prepared on the basis of the embodiment of the present invention, and a drive voltage was applied to each of the prepared organic EL devices, to measure the luminescent properties of the organic EL device.

### Inventive Example 1

The organic EL device in the inventive example 1 has the same structure as the organic EL device 100 shown in FIG. 1 except that a hole blocking layer 6 and an electron injection layer 7 were formed as one layer (hereinafter referred to as an electron transport layer).

In fabrication of the organic EL device in the inventive example 1, a hole injection electrode 2 composed of ITO was previously formed on a substrate 1 composed of a glass substrate, and the substrate 1 was cleaned using a mild detergent. Ultrasonic cleaning was performed in pure water for ten minutes, and was further performed in ethanol for ten minutes. Thereafter, a surface of the substrate 1 was cleaned by an ozone cleaner.

A hole injection electrode 3 composed of CuPc was formed on a surface of the hole injection electrode 2 composed of ITO by vacuum evaporation. The thickness of the formed hole injection layer 3 was 100 Å.

The hole injection layer 3 was formed at a vacuum of 1×10⁻⁶ Torr and on the condition that the substrate 1 is not subjected to temperature control.

Subsequently, a hole transport layer 4 composed of NPB was formed on a surface of the formed hole injection layer 3 by vacuum evaporation. The thickness of the formed hole transport layer 4 was 500 Å.

The conditions of vapor deposition of the hole transport layer 4 are the same as the conditions of vapor deposition of the hole injection layer 3.

Furthermore, a light emitting layer 5 was formed on a surface of the formed hole transport layer 4 by vacuum evaporation.

The light emitting layer 5 was formed by adding to a host material 5H composed of CBP a luminescent dopant D1 composed of btp2Ir(acac) and an assisting dopant D2 composed of Ir(ppy)3. The ratio of the luminescent dopant D1 to be added to the light emitting layer 5 was set to 6.5% by weight, and the ratio of the assisting dopant D2 to be added thereto was set to 2% by weight. The thickness of the formed light emitting layer 5 was 250 Å.

The conditions of vapor deposition of the light emitting layer 5 are the same as the conditions of vapor deposition of the hole injection layer 3.

An electron transport layer composed of BCP was formed on a surface of the formed light emitting layer 5 by vacuum evaporation. The thickness of the electron transport layer was 200 Å.

The conditions of vapor deposition of the electron transport layer are the same as the conditions of vapor deposition of the hole injection layer 3.

Finally, an electron injection electrode 8 composed of a magnesium-indium alloy (Mg:In=10:1) was formed on a surface of the formed electron transport layer by vacuum evaporation. The thickness of the formed electron injection electrode 8 was 2000 Å.

The conditions of vapor deposition of the electron injection electrode 8 are the same as the conditions of vapor deposition of the hole injection layer 3.

A drive voltage was applied by respectively positively and negatively biasing the hole injection electrode 2 and the electron injection electrode 8 in the organic EL device prepared in the above-mentioned manner, to measure the luminescent properties of the organic EL device.

As a result, the maximum luminescent wavelength of the organic EL device in the inventive example 1 was 620 nm, the maximum luminance thereof was 34700 cd/m², and the luminous efficiency thereof was 4.2 cd/A.

### Inventive Example 2

The organic EL device in the inventive example 2 has the same structure as the organic EL device in the inventive example 1 except for the following.

The ratio of a luminescent dopant D1 to be added to a light emitting layer 5 was set to 6.5% by weight, and the ratio of an assisting dopant D2 to be added thereto was set to 1% by weight. A drive voltage was applied by respectively positively and negatively biasing a hole injection electrode 2 and an electron injection electrode 8 in the organic EL device thus prepared, to measure the luminescent properties of the organic EL device.

As a result, the maximum luminescent wavelength of the organic EL device in the inventive example 2 was 620 nm, the maximum luminance thereof was 24200 cd/m², and the luminous efficiency thereof was 3.9 cd/A.

### Inventive Example 3

The organic EL device in the inventive example 3 has the same structure as the organic EL device in the inventive example 1 except for the following.

bt2Ir(acac) was used as an assisting dopant D2 in a light emitting layer 5.

The ratio of a luminescent dopant D1 to be added to the light emitting layer 5 was set to 6.5% by weight, and the ratio of the assisting dopant D2 to be added thereto was set to 2% by weight. A drive voltage was applied by respectively positively and negatively biasing a hole injection electrode 2 and an electron injection electrode 8 in the organic EL device thus prepared, to measure the luminescent properties of the organic EL device.

As a result, the maximum luminescent wavelength of the organic EL device in the inventive example 3 was 620 nm, the maximum luminance thereof was 27600 cd/m², and the luminous efficiency thereof was 3.8 cd/A.

### Inventive Example 4

The organic EL device in the inventive example 4 has the same structure as the organic EL device in the inventive example 1 except for the following.

Ir(ppy)3 was used as a luminescent dopant D1 in a light emitting layer 5, and FIrpic was used as an assisting dopant D2.

The ratio of the luminescent dopant D1 to be added to the light emitting layer 5 was set to 1.5% by weight, and the ratio of the assisting dopant D2 to be added thereto was set to 15% by weight. A drive voltage was applied by respectively positively and negatively biasing a hole injection electrode 2 and an electron injection electrode 8 in the organic EL device thus prepared, to measure the luminescent properties of the organic EL device.

As a result, the maximum luminescent wavelength of the organic EL device in the inventive example 3 was 515 nm, the maximum luminance thereof was 14200 cd/m², and the luminous efficiency thereof was 34.9 cd/A.

### Comparative Example 1

An organic EL device in a comparative example 1 was prepared on the basis of the embodiment of the present invention. A drive voltage was applied to the produced organic EL device, to measure the luminescent properties of the organic EL device.

The organic EL device in the comparative example 1 has the same structure as the organic EL device in the inventive example 1 except that an assisting dopant D2 is not added to a light emitting layer 5.

The ratio of a luminescent dopant D1 to be added to the light emitting layer 5 was 6.5% by weight. A drive voltage was applied by respectively positively and negatively biasing a hole injection electrode 2 and an electron injection electrode 8 in the organic EL device thus prepared, to measure the luminescent properties of the organic EL device.

As a result, the maximum luminescent wavelength of the organic EL device in the comparative example 1 was 620 nm, the maximum luminance thereof was 13000 cd/m², and the luminous efficiency thereof was 3.5 cd/A.

### Comparative Example 2

An organic EL device in a comparative example 2 was prepared on the basis of the embodiment of the present invention. A drive voltage was applied to the prepared organic EL device, to measure the luminescent properties of the organic EL device.

The organic EL device in the comparative example 2 has the same structure as the organic EL device in the inventive example 4 except that an assisting dopant D2 is not added to a light emitting layer 5.

The ratio of a luminescent dopant D1 to be added to the light emitting layer 5 was 1.5% by weight. A drive voltage was applied by respectively positively and negatively biasing a hole injection electrode 2 and an electron injection electrode 8 in the organic EL device thus prepared, to measure the luminescent properties of the organic EL device.

As a result, the maximum luminescent wavelength of the organic EL device in the comparative example 2 was 515 nm, the maximum luminance thereof was 8900 cd/m², and the luminous efficiency thereof was 28.5 cd/A.

[Evaluation]

From the results of the measurements of the luminescent properties of the organic EL devices in the inventive examples 1 to 4 and the comparative examples 1 and 2, comparison between the inventive examples 1 to 3 and the comparative example 1 and comparison between the inventive example 4 and the comparative example 2 were respectively made.

[Comparison Between Inventive Examples 1 to 3 and Comparative Example 1]

The results of the measurements of the luminescent properties of the organic EL devices in the inventive examples 1 to 3 and the comparative example 1 are as shown in the following

TABLE 1

| | Maximum | | |
|---|---|---|---|
| | Luminescent | Highest | Luminous |
| | Wavelength | Luminance | Efficiency |
| | (nm) | (cd/m2) | (cd/A) |
| Inventive | 620 | 34700 | 4.2 |
| Example 1 | | | |
| Inventive | 620 | 24200 | 3.9 |
| Example 2 | | | |
| Inventive | 620 | 27600 | 3.8 |
| Example 3 | | | |
| Comparative | 620 | 13000 | 3.5 |
| Example 1 | | | |

As shown in Table 1, the organic EL devices in the inventive examples 1 to 3 each containing the assisting dopant D2 can have a higher luminance and a higher luminous efficiency, as compared with those of the organic EL device in the comparative example 1 containing no assisting dopant D2.

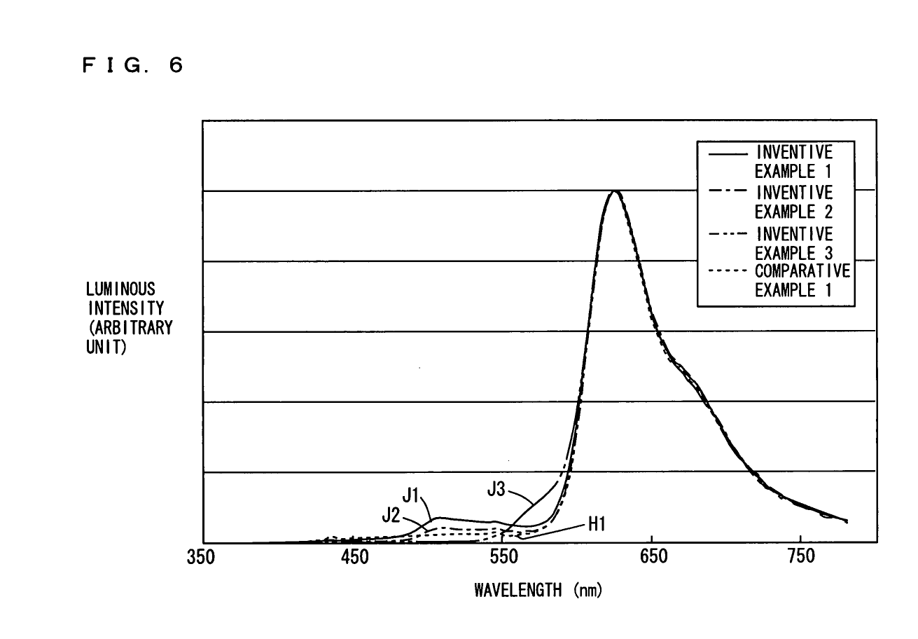

FIG. 6 is a graph showing the luminescent properties in the inventive examples 1 to 3 and the comparative example 1. The ordinate represents luminous intensity, and the abscissa represents luminescent wavelength. A solid line J1 indicates the luminescent properties of the organic EL device in the inventive example 1, a one-dot and dash line J2 indicates the luminescent properties of the organic EL device in the inventive example 2, a two-dot and dash line J3 indicates the luminescent properties of the organic EL device in the inventive example 3, and a dotted line H1 indicates the luminescent properties of the organic EL device in the comparative example 1.

As can be seen from FIG. 6, there is no significant difference in the luminescent properties in the vicinity of the maximum luminescent wavelengths between the inventive examples 1 to 3 and the comparative example 1. When the wavelength is in a range of approximately 450 nm to 600 nm, however, the luminescent properties in the inventive examples 1 to 3 tend to be slightly higher, as compared with the luminescent properties in the comparative example 1. It is considered that the difference in the luminescent properties between the inventive examples 1 to 3 and the comparative example 1 is due to light emission of the assisting dopant D2 itself.

The organic EL devices in the inventive examples 1 to 3 can thus emit light in a wide wavelength region.

As apparent from the foregoing results, the luminescent properties of the organic EL device are improved by adding the assisting dopant D2 satisfying the conditions given by the foregoing expressions (11) to (13) to the light emitting layer 5.

[Comparison Between Inventive Example 4 and Comparative Example 2]

The results of the measurements of the luminescent properties of the organic EL devices in the inventive example 4 and the comparative example 2 are as shown in the following

TABLE 2

| | Maximum | | |
|---|---|---|---|
| | Luminescent | Highest | Luminous |
| | Wavelength | Luminance | Efficiency |
| | (nm) | (cd/m2) | (cd/A) |
| Inventive | 515 | 14200 | 34.9 |
| Example 4 | | | |
| Comparative | 515 | 8900 | 28.5 |
| Example 2 | | | |

As shown in Table 2, the organic EL device in the inventive example 4 containing the assisting dopant D2 can have a higher luminance and a higher luminous efficiency, as compared with those of the organic EL device in the comparative example 2 containing no assisting dopant D2.

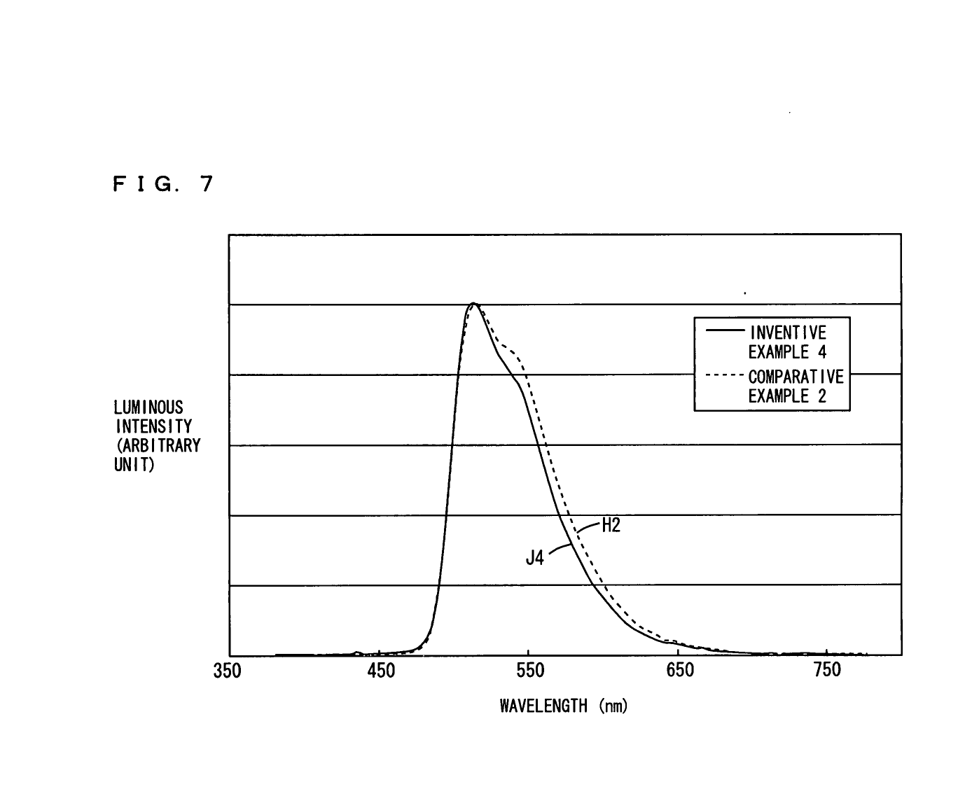

FIG. 7 is a graph showing the luminescent properties in the inventive example 4 and the comparative example 2. The ordinate represents luminous intensity, and the abscissa represents luminescent wavelength. A solid line J4 indicates the luminescent properties of the organic EL device in the inventive example 4, and a dotted line H2 indicates the luminescent properties of the organic EL device in the comparative example 2.

As can be seen from FIG. 7, in the luminescent properties in the inventive example 4, a luminescent wavelength region is narrower, as compared with that in the luminescent properties in the comparative example 2. It is considered that the change in the luminescent properties is due to the assisting dopant D2. Therefore, the organic EL device in the inventive example 4 can emit light in the narrow wavelength region.

As apparent from the foregoing results, the luminescent properties of the organic EL device are improved by adding the assisting dopant D2 satisfying the conditions given by the foregoing expressions (11) to (13) to the light emitting layer 5. Furthermore, it is apparent that the luminescent properties of the organic EL device vary depending on a combination of the assisting dopant D2 and the luminescent dopant D1, for example.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An organic electroluminescent device comprising:
a hole injection electrode;
a light emitting layer; and
an electron injection electrode in this order,
said light emitting layer containing
a luminescent dopant capable of converting triplet excitation energy into luminescence, and
an assisting dopant composed of a material capable of converting triplet excitation energy into luminescence and assisting in movement of the excitation energy to said luminescent dopant.

2. The organic electroluminescent device according to claim 1, wherein
said assisting dopant includes an ortho metalated complex.

3. The organic electroluminescent device according to claim 2, wherein
said ortho metalated complex includes a platinum group element.

4. The organic electroluminescent device according to claim 1, wherein
said assisting dopant includes an organic compound having a molecular structure expressed by any one of the following formulas (1) to (4),
M in the formulas (1) to (4) being a platinum group element,
R1 to R4 being a hydrogen atom, a halogen atom, or a substituent, and
n1 to n4 being integers from 1 through 3.

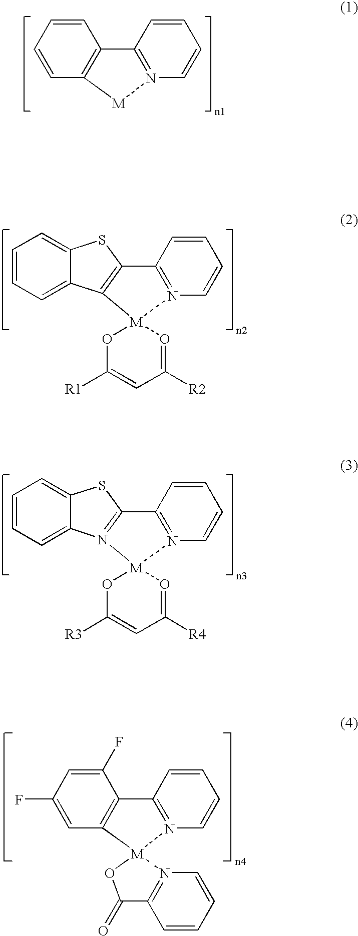

5. The organic electroluminescent device according to claim 3, wherein
said platinum group element is a metal selected from a group consisting of iridium, platinum, osmium, ruthenium, rhodium, and palladium.

6. The organic electroluminescent device according to claim 1, wherein
the content of said luminescent dopant in said light emitting layer is not less than 1% by weight nor more than 20% by weight.

7. The organic electroluminescent device according to claim 1, wherein
the content of said assisting dopant in said light emitting layer is not less than 1% by weight nor more than 20% by weight.

8. The organic electroluminescent device according to claim 1, wherein
the energy gap of said assisting dopant is greater than the energy gap of said luminescent dopant.

9. The organic electroluminescent device according to claim 1, wherein
said light emitting layer further contains a host material,
the energy level H0 of the highest occupied molecular orbit of said host material, the energy level H1 of the highest occupied molecular orbit of said luminescent dopant, and the energy level H2 of the highest occupied molecular orbit of said assisting dopant satisfy a relationship of H0>H2>H1, and
the energy level L0 of the lowest unoccupied molecular orbit of said host material, the energy level L1 of the lowest unoccupied molecular orbit of said luminescent dopant, and the energy level L2 of the lowest unoccupied molecular orbit of said assisting dopant satisfy a relationship of L0>L2>L1.

10. The organic electroluminescent device according to claim 1, wherein
said assisting dopant emits light.

11. The organic electroluminescent device according to claim 10, wherein
the luminous intensity of said assisting dopant is not more than 30% of the luminous intensity of said luminescent dopant.

12. An organic electroluminescent device comprising:
a hole injection electrode;
a light emitting layer; and
an electron injection electrode in this order,
said light emitting layer containing
a luminescent dopant capable of converting triplet excitation energy into luminescence, and
an assisting dopant composed of a material capable of converting triplet excitation energy into luminescence and assisting in transportation of carriers to said luminescent dopant.
